(19) United States
(12) Patent Application Publication
(10) Pub. No.: US 2013/0276374 A1
(43) Pub. Date: Oct. 24, 2013

(54) SLIDING DOOR STRUCTURE

(71) Applicants: MIN-HSIANG HSU, NEW TAIPEI CITY (TW); CHING-FENG HSIEH, TAIPEI CITY (TW)

(72) Inventors: MIN-HSIANG HSU, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/525,622

(22) Filed: Jun. 18, 2012

(30) Foreign Application Priority Data
Apr. 24, 2012 (TW) 101114503

(51) Int. Cl. E05D 15/06; E06B 3/46

(52) U.S. Cl. 49/452

(57) ABSTRACT

A sliding door is coupled to a casing having therein a receiving space, a port received in the receiving space, a first opening formed at the casing, and a first guide rail fixed to the casing to face the receiving space and positioned proximate to the first opening. The sliding door includes a frame body and a door body. The frame body is received in the receiving space and has a second guide rail, a resilient arm, and a second opening corresponding in position to the first opening. The door body is disposed between the casing and the frame body and slides along the first guide rail and the second guide rail to selectively block or unblock the first opening and the second opening. Accordingly, the sliding door structure is selectively opened or shut as needed, so as to protect the port.

### CROSS-REFERENCE TO RELATED APPLICATION

This non-provisional application claims priority under 35 U.S.C. §119(a) on Patent Application No(s). 101114503 filed in Taiwan, R.O.C. on Apr. 24, 2012, the entire contents of which are hereby incorporated by reference.

### FIELD OF TECHNOLOGY

The present invention relates to sliding door structures, and more particularly, to a sliding door structure applicable to a casing having a port.

### BACKGROUND

A conventional portable electronic device is typically equipped with a plurality of ports 4 (as shown in FIG. 1), such as a Mini-USB port and a USB port. To make the conventional portable electronic device look tidy and good-looking and prevent dust from accumulating at the ports 4, it is necessary to cover and conceal the ports 4 with a sliding door structure 2 made of rubber or a soft plastic material.

However, the sliding door structure 2 made of rubber or a soft plastic material proves unfit to protect the ports 4 of the portable electronic device against an external impact. The sliding door structure 2 comprises a door body 6 and a connection element 8. The connection element 8, however, disadvantageously restricts the opening and shutting movement of the door body 6 to a specific angle, direction, and manner. For example, in the situation where one of the ports has to be connected to a battery charger (not shown), the battery charger has to be equipped with a specific charging connector suitable for operating smoothly in the open state of the door body 6, thereby bringing inconvenience to users. The door body 6 and the connection element 8 are made of rubber or a flexible plastic material. Due to the low tensile strength and low modulus of elasticity of rubber and flexible plastic materials, the door body 6 and the connection element 8 are likely to sever or deform when pulled and stretched hardly.

Accordingly, it is imperative to provide a sliding door structure capable of protecting the ports of an electronic device.

### SUMMARY

It is an objective of the present invention to provide a sliding door structure capable of protecting a port of an electronic device.

In order to achieve the above and other objectives, the present invention provides a sliding door structure coupled to a casing having a receiving space therein and a port received therein. The casing has a first opening and is provided with a first guide rail fixed to the casing to face the receiving space and positioned proximate to the first opening. The sliding door structure comprises a frame body and a door body. The frame body is received in the receiving space and has a second guide rail, a resilient arm, and a second opening corresponding in position to the first opening. The resilient arm is disposed at the frame body and positioned proximate to the second opening. The door body is disposed between the casing and the frame body. The door body has a first sliding portion, a second sliding portion, and at least a stop portion. The first sliding portion and the first guide rail are coupled together. The second sliding portion and the second guide rail are coupled together. The door body slides along the first guide rail and the second guide rail to change a state of communication between the first opening and the second opening, such that the resilient arm abuts against the at least a stop portion and thereby enables the door body to be positioned stepwise.

Compared with the prior art, the present invention provides a sliding door structure characterized advantageously by mutual interaction between a casing, a frame body, and a door body such that it is feasible to determine whether a port inside the casing should communicate with the outside of the casing by giving considerations based on the movement of the door body between the casing and the frame body, thereby protecting the port.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a partial schematic view of a sliding door structure;

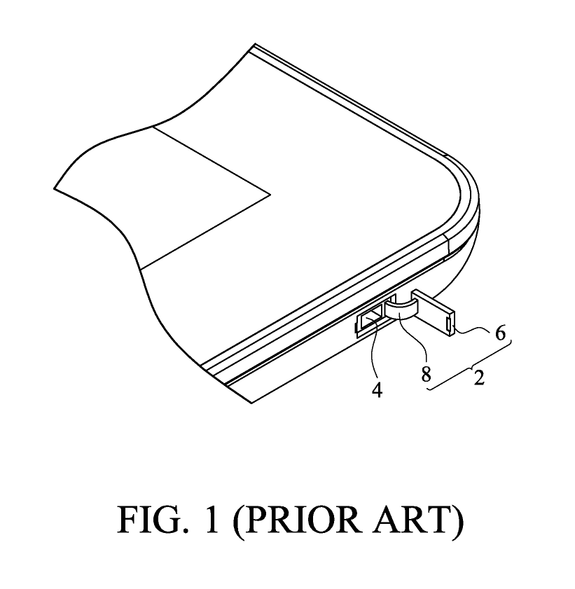

FIG. 2 is a partial front exploded schematic view of a sliding door structure according to an embodiment of the present invention;

FIG. 3 is a partial rear exploded schematic view of the sliding door structure of FIG. 2;

FIG. 4 is a partial front schematic view of the shut sliding door structure of FIG. 2;

FIG. 5 is a partial front schematic view of the opened sliding door structure of FIG. 2;

FIG. 6 is a partial rear schematic view of the assembled sliding door structure of FIG. 2; and

FIG. 7 is a perspective view of a door body of the sliding door structure of FIG. 2.

### DETAILED DESCRIPTION

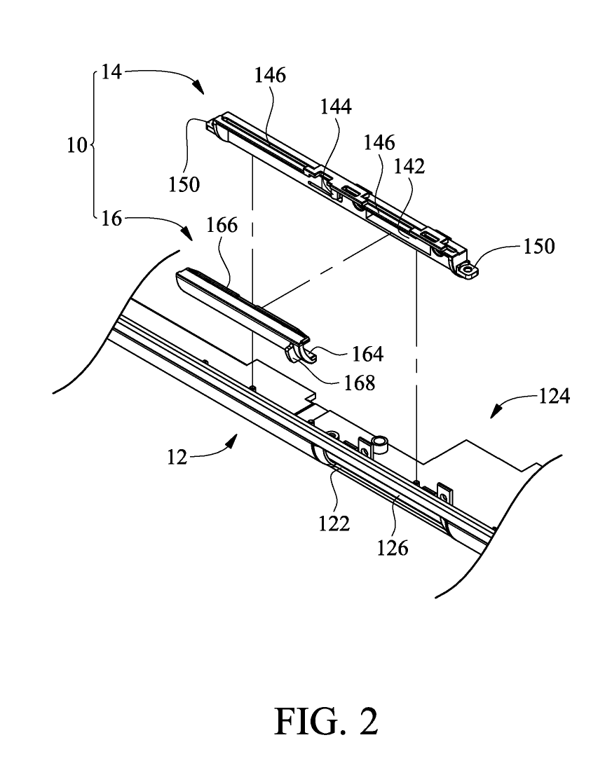

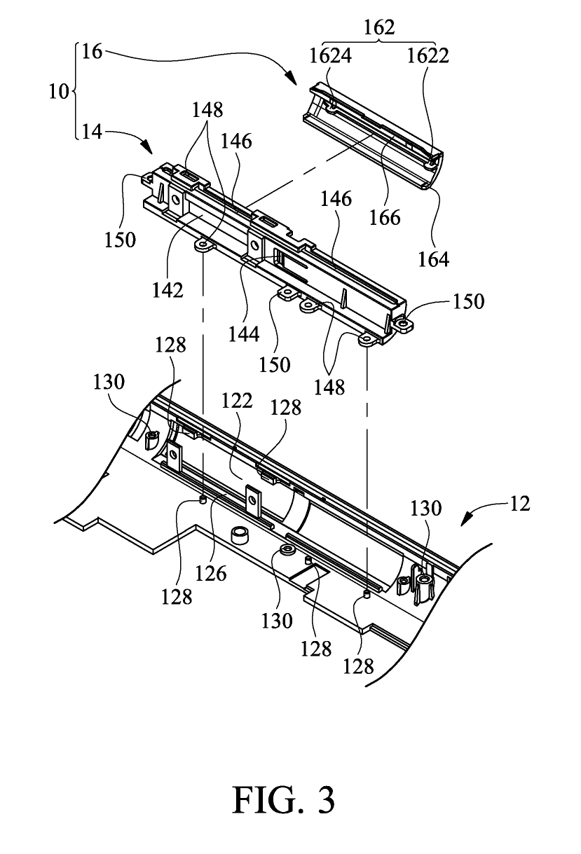

Referring to FIG. 2 and FIG. 3, there are shown a partial front exploded schematic view and a partial rear exploded schematic view of a sliding door structure according to an embodiment of the present invention.

Referring to FIG. 2, a sliding door structure 10 is coupled to a casing 12 to protect a port (not shown) disposed in a receiving space 124 of the casing 12. A first opening 122 is formed at the casing 12. A first guide rail 126 is fixed to the casing 12 to face the receiving space 124 and positioned proximate to the first opening 122. In this embodiment, the casing 12 is exemplified by a lower casing of a tablet computer, and the first opening 122 is disposed at the lower casing. The port is a USB port, a Mini-USB port, a HDMI port, a Dock port, or a memory card slot.

The sliding door structure 10 comprises a frame body 14 and a door body 16.

The frame body 14 is disposed in the receiving space 124. The frame body 14 has a resilient arm 144 and a second guide rail 146. The second guide rail 146 corresponds in position to the first guide rail 126. The frame body 14 is formed with a second opening 142 corresponding in position to the first opening 122. If the first opening 122 and the second opening 142 are unobstructed (to be described in detail below), the port can be exposed from the casing 12. The resilient arm 144 is positioned proximate to the second opening 142.

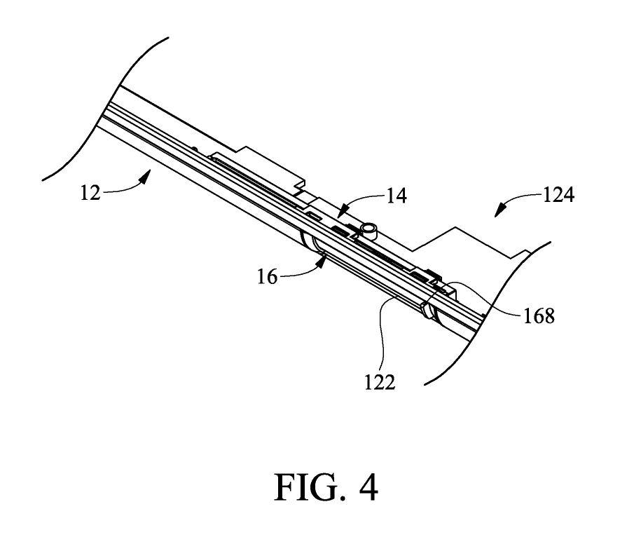

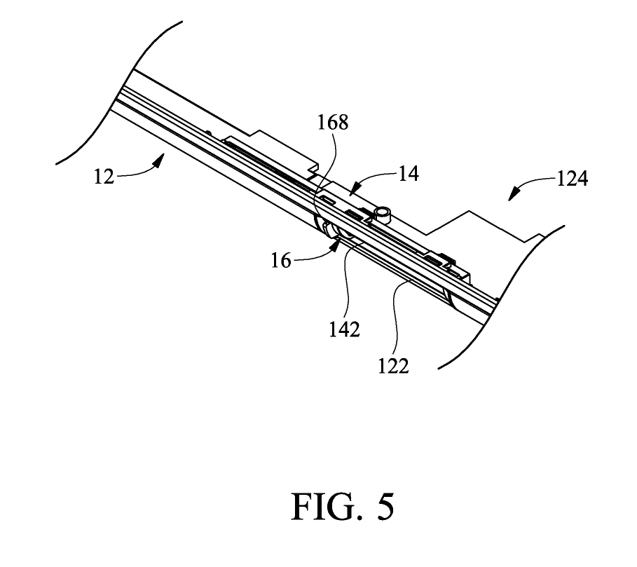

Referring to FIG. 3, the door body 16 further has at least a stop portion 162, a first sliding portion 164, and a second sliding portion 166. The door body 16 is slidably engaged with the first guide rail 126 through the first sliding portion 164. The door body 16 is slidably engaged with the second guide rail 146 through the second sliding portion 166. The at least a stop portion 162 is disposed at the door body 16 and corresponds in position to the resilient arm 144. The resilient arm 144 abuts against the at least a stop portion 162 to enable the door body 16 to be slided and positioned stepwise. The door body 16 is disposed between the casing 12 and the frame body 14. To protect the port disposed in the receiving space 124 of the casing 12, a user can slide the door body 16 along the first guide rail 126 and the second guide rail 146 until the door body 16 lies between the first opening 122 and the second opening 142 to block the first opening 122 and the second opening 142 as shown in FIG. 4. To access the port disposed in the receiving space 124 of the casing 12, the user can slide the door body 16 out of the way of the first opening 122 and the second opening 142 as shown in FIG. 5.

Referring to FIG. 3, the at least a stop portion 162 is exemplified by two said stop portions 162 disposed on one side of the door body 16 and positioned proximate to two ends of the door body 16, respectively, The two said stop portions 162 are defined as a first stop portion 1622 and a second stop portion 1624. The stop portions 162 fasten the resilient arm 144 in place and thereby stop and position the door body 16, such that the door body 16 can be slided stepwise. If the door body 16 gets out of the way of the first opening 122 and the second opening 142 completely, the second stop portion 1624 will be fastened to the resilient arm 144. If the door body 16 gets in the way of the first opening 122 and the second opening 142 completely, the first stop portion 1622 will be fastened to the resilient arm 144. In doing so, the user can have an idea as to whether the door body 16 has opened or shut completely.

The dimensions of the door body 16 are no less than the dimensions of the first opening 122, respectively. The door body 16 is made of a rigid plastic material for withstanding any external impact and thereby protecting the port.

The frame body 14 further comprises a plurality of first positioning portions 148 formed at the edges of the frame body 14. The casing 12 comprises a plurality of second positioning portions 128 corresponding in position to the first positioning portions 148, respectively. The first positioning portions 148 and the second positioning portions 128 can be coupled to each other, respectively, such that the frame body 14 is fixed to the casing 12. In this regard, the first positioning portions 148 are each exemplified by a ring-shaped structure, and the second positioning portions 128 are each exemplified by a post-like structure. The ring-shaped structures can be disposed around the post-like structures, respectively, so as for the frame body 14 to be fixed to the casing 12, thereby preventing the frame body 14 from loosening.

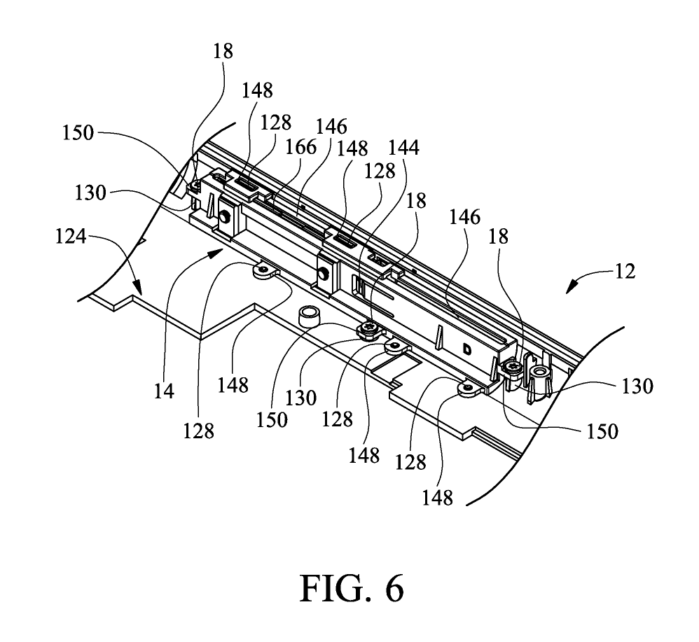

The frame body 14 further comprises a plurality of first fastening portions 150 formed at the edges of the frame body 14. A plurality of second fastening portions 130 is disposed at the casing 12 and corresponds in position to the first fastening portions 150. In this regard, the first fastening portions 150 are each exemplified by a ring-shaped structure, and the second fastening portions 130 are each exemplified by a nut-like structure. Referring to FIG. 6, the first fastening portions 150 are fastened to the second fastening portions 130 by means of fastening elements 18, respectively, such that the frame body 14 is fixed to the casing 12.

Due to the aforesaid positioning function and the aforesaid fixing function provided by the first positioning portions 148, the second positioning portions 128, the first fastening portions 150, the second fastening portions 130, and the fastening elements 18, the frame body 14 can be positioned at and fixed to the casing 12 as shown in FIG. 6.

Referring to FIG. 2 and FIG. 3, the door body 16 further comprises an operation element 168 disposed at the door body 16. The operation element 168 is opposite the stop portions 162 and corresponds in position to the first opening 122. The operation element 168 is operable by the user in order to move the door body 16, such that the door body 16 slides along the first guide rail 126 and the second guide rail 146.

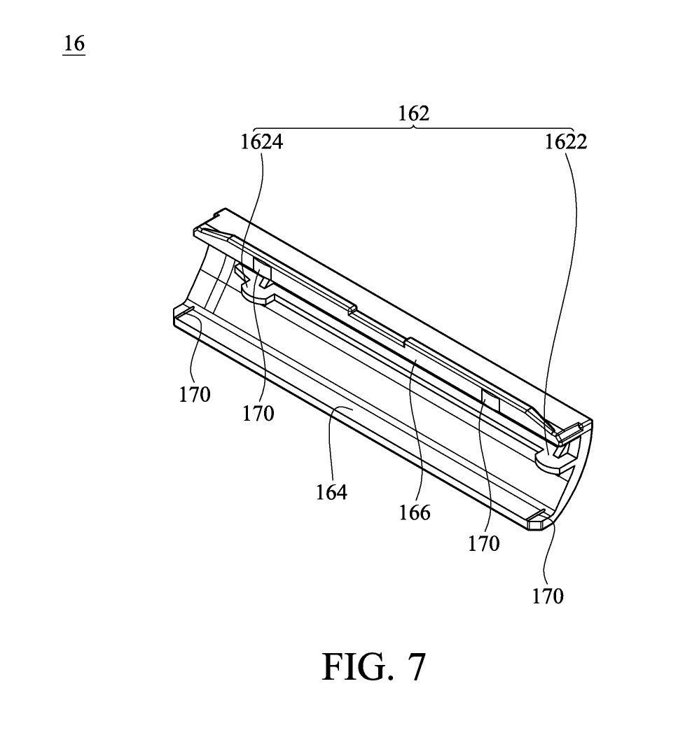

Referring to FIG. 7, the door body 16 further comprises a plurality of contact elements 170 disposed at at least one of the second sliding portion 166 and the first sliding portion 164. In this embodiment, the contact elements 170 are disposed at both the second sliding portion 166 and the first sliding portion 164 to enable the door body 16 to come into point contact or linear contact with the frame body 14. For example, the contact elements 170 come in the form of raised dots or bumps.

In this embodiment, the contact elements 170 are exemplified by the bumps, and the door body 16 slides and comes into a mere linear contact with the frame body 14 to reduce the friction between the door body 16 and the frame body 14, reduce the noise resulting from the sliding of the door body 16, prevent the door body 16 from colliding with the frame body 14, and enable the door body 16 to open and shut smoothly.

In conclusion, the present invention provides a sliding door structure coupled to a casing and comprising a frame body and a door body. The door body can be opened to expose a port from the casing. The door body can be shut to conceal and protect the port. The door body is not only slided smoothly and stepwise, but also positioned and stopped precisely.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A sliding door structure coupled to a casing having therein a receiving space, a port received in the receiving space, a first opening formed at the casing, and a first guide rail fixed to the casing to face the receiving space and positioned proximate to the first opening, the sliding door structure comprising:
a frame body disposed in the receiving space, having a second guide rail and a resilient arm, and formed with a second opening corresponding in position to the first opening, wherein the resilient arm is disposed at the frame body and positioned proximate to the second opening; and
a door body disposed between the casing and the frame body and having a first sliding portion, a second sliding portion, and at least a stop portion, the first sliding portion being slidably engaged with the first guide rail, the second sliding portion being slidably engaged with the second guide rail so as to allow the door body to slide along the first guide rail and the second guide rail and thereby selectively block or unblock the first opening and the second opening, wherein the resilient arm abuts against the at least a stop portion to enable the door body to be positioned stepwise.

2. The sliding door structure of claim 1, wherein the frame body further comprises first positioning portions formed at edges of the frame body, and the casing is formed with second positioning portions corresponding in position to the first positioning portions, respectively, such that the first positioning portions are coupled to the second positioning portions, respectively, to fix the frame body to the casing.

3. The sliding door structure of claim 1, wherein the frame body further comprises first fastening portions formed at edges of the frame body, and the casing is formed with second fastening portions corresponding in position to the first fastening portions, respectively.

4. The sliding door structure of claim 3, further comprising fastening elements disposed at the first fastening portions and the second fastening portions to fasten the frame body to the casing.

5. The sliding door structure of claim 3, wherein the door body further comprises an operation element disposed at the door body for moving the door body.

6. The sliding door structure of claim 1, wherein the door body further comprises a contact element disposed at at least one of the second sliding portion and the first sliding portion for allowing the door body to come into point contact or linear contact with the frame body.

7. The sliding door structure of claim 1, wherein, in case of plural said stop portions, the stop portions are disposed at two ends of the door body.

8. The sliding door structure of claim 1, wherein dimensions of the door body are no less than dimensions of the first opening, respectively.
